(19) United States
(12) Patent Application Publication
(10) Pub. No.: US 2014/0170894 A1
(43) Pub. Date: Jun. 19, 2014

(54) Twist Lock Connector Locking Mechanism

(71) Applicant: Michael D. McCulley, Anthem, AZ (US)

(72) Inventor: Michael D. McCulley, Anthem, AZ (US)

(21) Appl. No.: 14/092,754

(22) Filed: Nov. 27, 2013

Related U.S. Application Data
(60) Provisional application No. 61/739,298, filed on Dec. 19, 2012.

(51) Int. Cl. H01R 13/639

(52) U.S. Cl. CPC H01R 13/639
USPC 439/372

(57) ABSTRACT

A terminated cable retainer uses a locking rod to engage an edge on the terminal end of a cable as the locking rod urges the cable into a locked position. The device is for use with high-speed data connections, such as header blocks commonly found in universal broadband router installations. The lock rod or rotatable shaft provides for a twist lock that will hold a terminal end of a cable in a header block.

### CROSS REFERENCE TO RELATED APPLICATION

This application claims the benefit of Provisional Application No. 61/739,298; titled “Twist Lock Connector Locking Mechanism”; Michael D. McCulley, inventor; filed Dec. 19, 2012. The aforementioned Provisional application is hereby incorporated by reference in its entirety.

### BACKGROUND OF THE INVENTION

1. Field of the Invention

This invention is a cable connector-restraining device for use with high-speed data connections, such as header blocks commonly found in universal broadband router installations. The improvement provided to the header block is the provision of a lock rod to hold multiple cables in place in the header block. The connector-locking rod disclosed provides for a twist lock that will securely hold the terminal end of a cable in a header block. The connector locking rod is rotated to lock cables in a retained position and is counter rotated to allow release of terminal ends of a cable or cables inserted into a header block. The connectors involved are generally of the type used to connect one type of data cable to another type of data cable, printed circuit board, backplane, and/or patch panel. Each connector will have a lip or margin that is engagable with the locking rod when the connector is inserted in a header block and the locking rod is rotated into a locking position.

2. Description of Known Art

This device is an embodiment that secures cable connectors inside a header block. The header block is of the type that is used in a system including multiple connectors connecting Ethernet-type fiber, and/or coax cables to/from the header and to/from a modem/universal broadband router or any type of equipment connected to another piece of equipment through multiple cables. Each cable has a connector at, at least, one end of the cable. The connector end is inserted into the header block and retained in place by apparatus unlike the connector locking rod presented herein.

There are many patents pertaining to cable connectors as it is important to make the connectors easy to configure and load with desired cable while being secured to a connector, frame or other connection point. A patent to Zieman, et al., U.S. Pat. No. 7,927,125 discloses cable connectors and a means of locking a set of cables into a cable connector. Zieman is markedly different from the cable connector locking apparatus disclosed here. In Zieman a sliding locking element is used to retain cables in an installed position. The rotatable connector locking rod presented here does not incorporate a sliding locking element. Also, patents to Saito, et al. (U.S. Pat. No. 5,830,013); Oda, et al. (U.S. Pat. No. 5,486,122); and Kurimoto (U.S. Pat. No. 6,655,998) show different embodiments of connector. Each of these patents, the Zieman, the Saito, the Oda, and the Kurimoto patents are herein incorporated by reference. None of these patents disclose the invention set forth herein.

Applicant believes that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicants will amend the specification to expressly recite the essential material that is incorporated by reference as allowed by the applicable rules.

### BRIEF SUMMARY OF THE INVENTION

The present invention provides, among other things, a header block and cable connector that is capable of securing and locking cables in connections of a header block. The locking provision of the rotatable connector locking rod is accomplished by the use of one or more rotatable elements, herein referred to as locking rods, extending transversely across a locking block or header block. Cables, the cable being a generally flexible wire or group of wires in a sheath and including a fitting or ferrule on the end of the wire that is inserted into the header block. These cables have a lip or margin, most usually formed where the wire portion of the cable is inserted into the ferrule, the ferrule is crimped, machined, compressed, or molded on to the end of the wire or wire bundle. The ends of the cables, the ferrule end of the cable at least, are inserted into a header block or fixture where the inserted cable is connected to another cable or receiving connector constrained in the header block, using a sliding fit connection. With the two connectors positioned in the fixture and connected together, the rotatable connector locking device of this disclosure is used to hold the connected cables in the fixture. The fixture is also referred to as a header block. The header block is generally connected to a printed circuit board on one side and to cables that are inserted or removed on the other side of the header block. The rotatable connector locking rod device presented here comprises a rotatable lock rod that is rotated or twisted from an open position to a locked position.

An object of this invention is to use a rotating shaft or locking rod that will urge or push the end of a cable, having a connector, into a firm connection with a mating connector as the locking rod is rotated into a locking position.

Another object of this invention is to provide a rotating lock rod that will securely hold a cable in a cable connection fixture or header block.

It is also an object to provide a rotatable or twistable lock rod that can be twisted or rotated from an unlocked position to a locked position and from a locked position to an unlocked position.

It is also an object of this invention to provide a rotatable connector locking rod used in a locking block.

Another aspect of the invention is that the lock or rotatable connector locking rods can be twisted or rotated but are restrained from rotation in the locking block by use of a setscrew.

Another aspect of the invention is that the lock or rotatable connector locking rods can be twisted or rotated but are restrained from rotation in the locking block by use of a locking clip.

Another aspect of the invention is that the lock or rotatable connector locking rods can be twisted or rotated but are restrained from rotation in the locking block by use of a spring lock.

Another advantage of the invention is that the lock rods are equipped with a twist knob, or lever, connected directly or indirectly, such as by a gear drive or friction drive, that precludes the need for special tools to lock or unlock the locking device.

Another aspect of the invention is that the lock or rotatable connector locking rods can be formed with screwdriver or wrench receiving ends for rotating the lock rods from an open position to a locked position.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112, ¶6. Thus, the use of the words “function,” “means” or “step” in the Detailed Description or Description of the Drawings or claims is not intended to somehow indicate a desire to invoke the special provisions of 35 U.S.C. §112, ¶6, to define the invention. To the contrary, if the provisions of 35 U.S.C. §112, ¶6 are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112, ¶6. Moreover, even if the provisions of 35 U.S.C. §112, ¶6 are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the drawings in which:

FIG. 1 is a top view of a header block with a twist lock connector locking mechanism carried in the block with some elements shown in phantom lines;

FIG. 2 is a front elevation view of the device of FIG. 1;

FIG. 3 is a detailed view of detail “B” of FIG. 2;

FIG. 4 is a side elevation view of FIG. 1;

FIG. 5 is a detailed view of detail “A” of FIG. 4;

FIG. 6 is a projected view of the twist lock connector locking mechanism;

FIGS. 7a-7g are various views of the twist lock connector locking mechanism shown in FIG. 6;

FIG. 8 is a detailed view of detail “C” of FIG. 7e;

FIGS. 9a-9b show typical ends used on cables that are contained in the rotatable lock connector locking mechanism;

FIGS. 10a-10d are an alternative location of the rotatable or twist lock connector locking mechanism;

FIGS. 11a-11b show an embodiment of one rotatable locking rod in a first position and in a rotated position.

FIG. 11c shows the locking rod of FIGS. 11a-11b in better detail than is shown in FIGS. 11a-11b.

FIG. 12 is a projected view of a rotatable locking rod assembly having an alternative embodiment of lock rod rotating handles.

FIG. 13a-d is an alternative rotatable locking rod configuration showing a locking rod configured to provide more contact area between the locking rods and the end of the connector being retained by the locking rod.

FIG. 14 is an alternative rotatable locking rod configuration showing two locking rods configured to provide more contact area between the locking rods and the end of the connector being retained by the locking rods.

Elements and acts depicted in the figures are illustrated for simplicity. They are presented to illustrate the invention to assist in an understanding thereof. The figure is not necessarily been rendered according to any particular sequence, size, scale or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the invention is not limited to the examples that are described below.

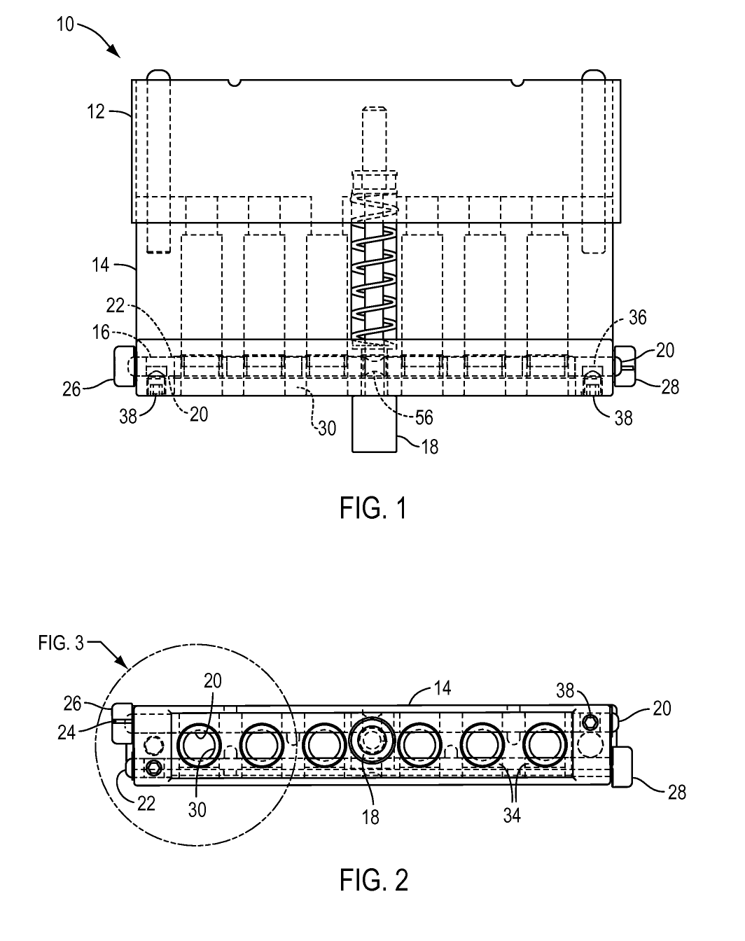

Turning to FIG. 1, one embodiment of a rotatable or twist lock connector locking mechanism, generally 10 is shown. Missing are the actual cables and connectors, for instance Ethernet cables, fiber or coax cables, that would be secured in a header block as used in a universal broadband router system. It is usual for the terminal ends of such cables to have a projecting edge inboard of the end of the cable. Often this is formed in the ferrule clamped on the end of the cable or is the ferrule itself where the inner most end of the ferrule overlaps the cable or wire. In another embodiment, the twist lock connector locking mechanism is often connected directly to a printed circuit board or several printed circuit boards as part of a backplane. Cables are secured to the twist lock connector locking mechanism and are locked in place completing a circuit from a cable to the printed circuit board. In the illustrated embodiment of the invention, a radio frequency (“RF”) shield 12 is indexed to a header block 14. A front portion of the header block 14 is provided with a lock rod bore 16. The bore 16 could be a through bore extending from one exterior surface of the header block, also referred to as a housing, to and through a second exterior surface of the housing or header block 14. Alternatively the bore could be a blind bore in the housing or header block 14. In an installed deployment the header block 14 is held in place by a tension compensated lead screw 18.

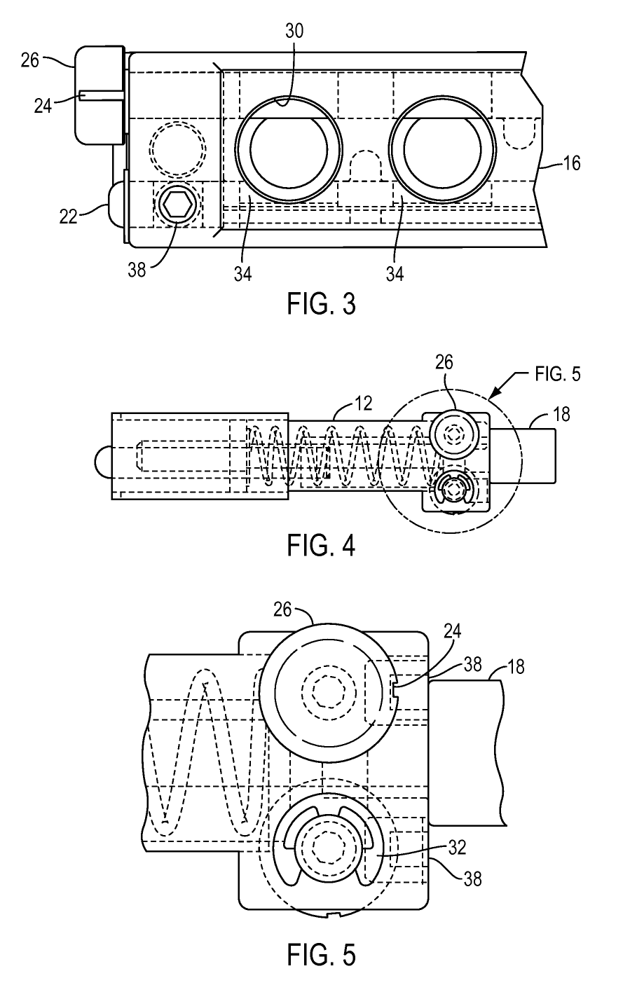

In FIG. 1 the upper locking rod 20 is shown having a knob 26. A second knob 28 is attached to a second or lower locking rod 22 as best seen in FIGS. 2 and 3.

FIG. 2 shows a plurality of access bores or cable receiving bores such as 30 (one of six shown) and the end view of the lead screw 18. In an alternative embodiment as few as one access bore will be provided, however in most installations more than one cable receiving access bore will be used. In this FIG. 2 view the locking rods, upper locking rod being 20 and lower locking rod 22 are illustrated. The upper locking rod 20 is in a locked position as evidenced by the position of the locked indicator slot 24 on the twist knob 26. The twist knob is also referred to as a “shaft rotation apparatus” as it may be an apparatus other than a twist knob. The locked indicator slot 24, indicating a locked position of the locking rods when the indicator is facing the front of the header block as shown in FIG. 2, could alternatively be replaced with a tab serving the same purpose as the indicator slot. Also notice in FIGS. 2 and 3 that a portion of the upper locking rod is shown in a locked deployment (no cables are in place) at the top of each access bore or cable receiving bore 30. The lower lock rod 22, with its twist knob 28, is rotated to an unlocked position. For a cable, usually equipped with a cable ferrule, to be inserted into an access bore both the upper and lower locking rods, 20 and 22, would be rotated or twisted to the open position as is the lower locking rod 22 in FIGS. 2 and 3.

The lock or locking rods, upper and lower 20 and 22 respectively, are cylindrical rods with a locking rod rotation apparatus such as a twist knob, tab, wrench fitting, or other suitable mechanical or automated apparatus that could be used to rotate a locking rod, at one end. The other end of the locking rods comprises a groove for accommodating a locking ring such as 32 in FIG. 5. Each locking rod is machined, molded, or cast to include at least one, and usually more than one, planar surface or flat portion such as the flat portions 34 as best seen in the broken line (hidden surface) rendition in FIG. 3. Each locking rod is also machined with a set screw flat 36, best seen in FIG. 1. A setscrew 38 is threaded into the locking block 16 to interface with the setscrew flat 36. The set screw flat could be an indentation for receiving the set screw to more positively prevent the locking rods from being inadvertently rotated while they are expected to be locking in place. This set screw provision also prevents the removal of the locking rods from the header block as the set screw flat 36 is machined into each locking rod and thus provides an edge that hits the set screw if the locking rod is moved laterally while the set screw is screwed into its threaded bore. The set screw may also be used to prevent the undesired rotation of the locking rods once all cables are in place in the access bores and locked. Alternatives to the set screw embodiment include screw down levers, screw gears and spring locks.

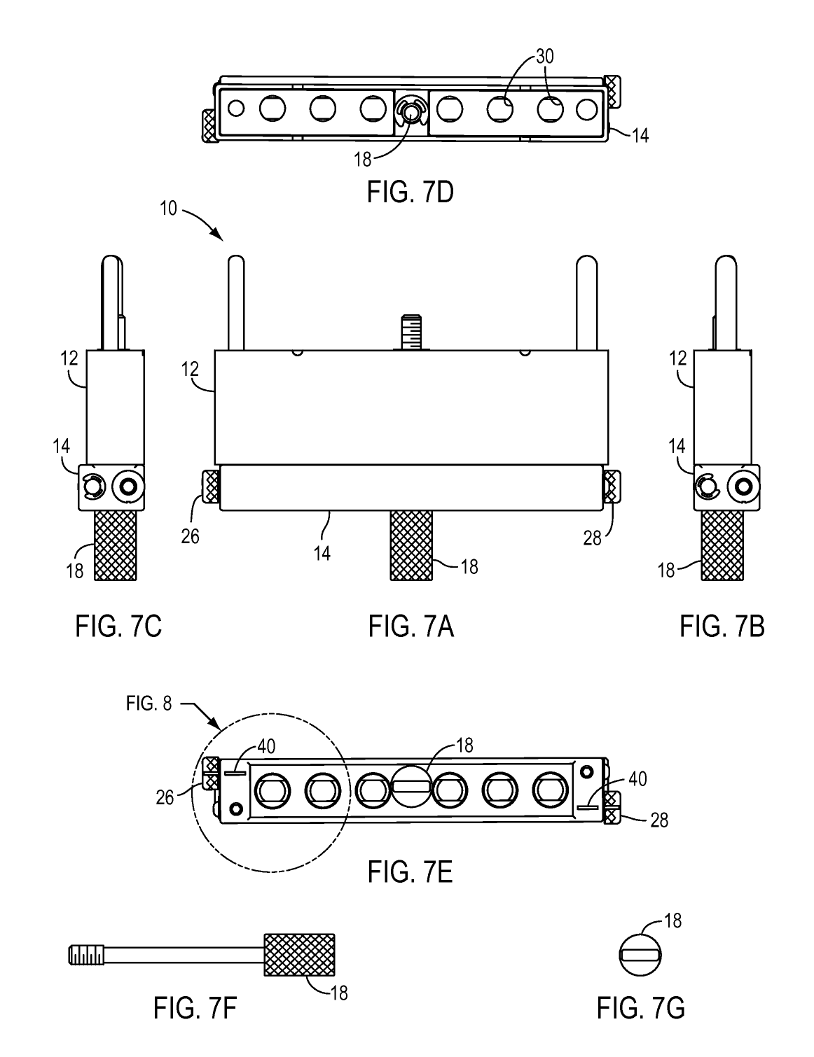

FIGS. 3-5 are enlarged elements taken from various sections of the header block 14 and help to envision the configuration and placement of the various components mentioned above. In FIGS. 4 and 5 there are elevation views showing how the shaft or shank of the lead screw 18 is positioned in an aperture that is between the upper and the lower locking rod bores. This allows the locking rods to extend continuously from one end of the header block 14 to the other end of the header block. In one embodiment of the locking rods as groove, normally a rounded groove as is shown as item 56 is machined in one or both of the locking rods. This will allow passage of the shank of the lead screw between the locking rods if it is necessary to have the upper and lower locking rods relatively vertically close to each other. FIG. 7 also shows the lead screw and its passage between the locking rods.

In another embodiment of the invention the locking rods, also referred to as “rotatable shafts,” are used to lock cables directly into a frame or structure that does not rely on the use of a header block. In this embodiment the cables would be inserted into the face panel of the structure and locked in place using locking rods as described above that have been fitted directly to the faceplate of the frame or structure.

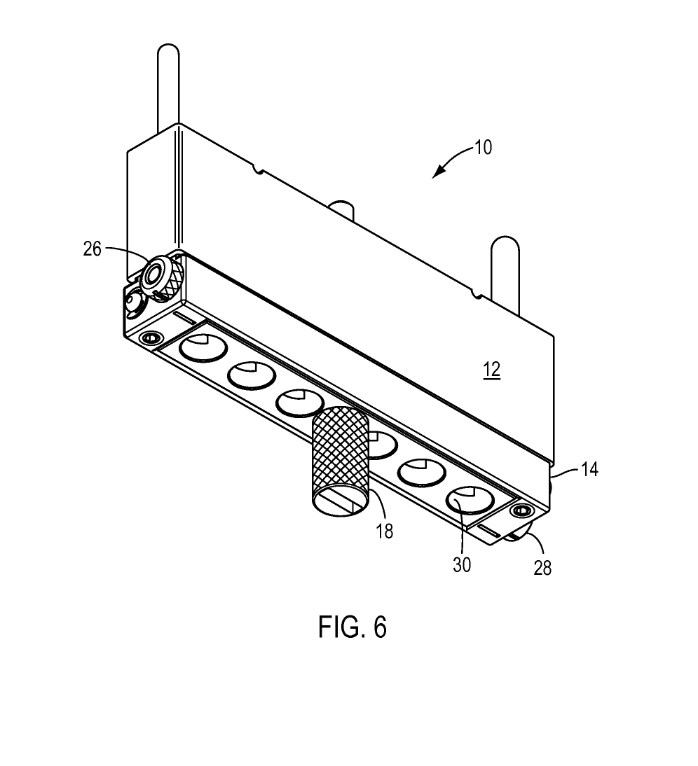

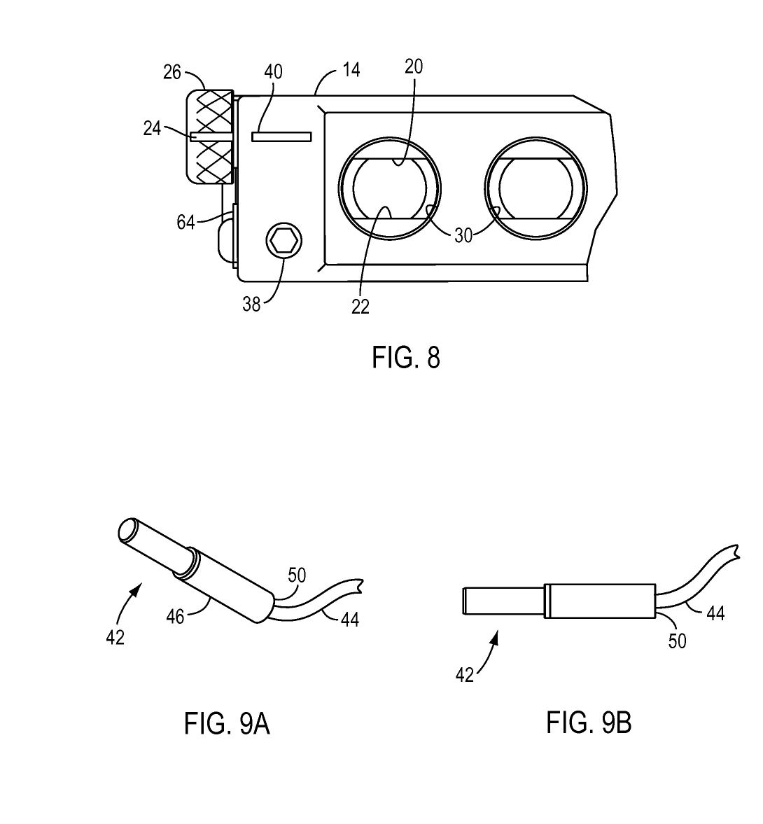

FIGS. 6-8 are depictions of one embodiment of the invention. In FIGS. 6 and 7 the RF shield 12 is not shown. This embodiment is very similar to the embodiment shown in FIGS. 1-5 but does not include the hidden lines as used in FIGS. 1-5. One item clearly shown in FIGS. 7e and 8 is an optional index indicator line 40. This line may be helpful in lining up the locked indicator slot 24 to show the locking rod is in the locked position.

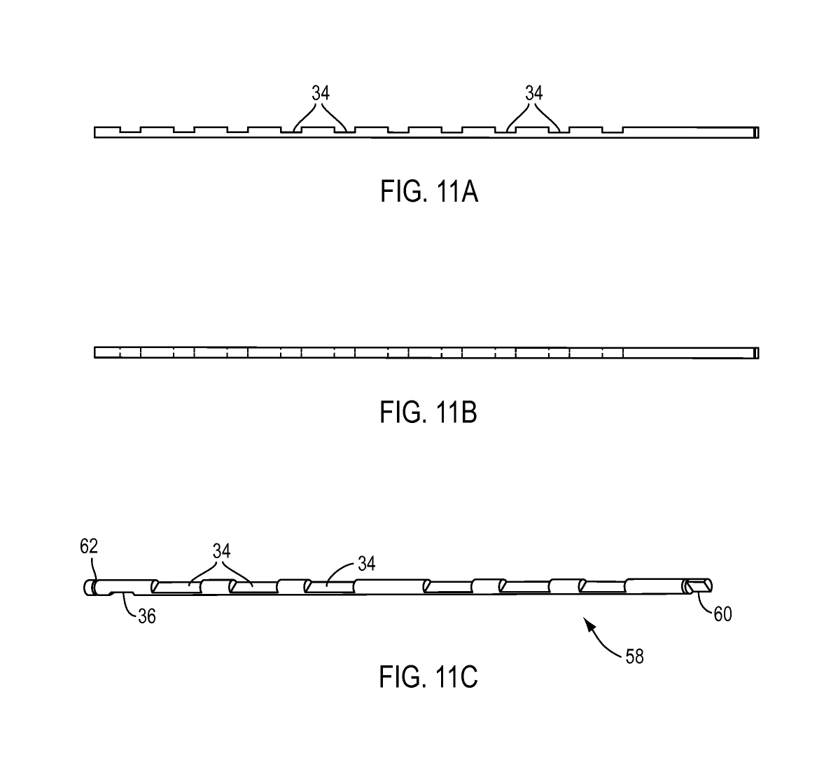

In FIGS. 7a-7fg the lead screw is shown as item 18. The lead screw has a shank portion that extends from the knurled end to a termination point on the relative backside of the RF shield 12. The sizing of the shank of the lead screw is such that the lead screw passes between the upper and the lower locking rods. In certain situations a groove may have to be machined in one or both locking rods to allow passage of the lead screw. In other embodiments no groove needs to be formed in the locking rods (see FIGS. 11a-c).

FIGS. 9a-9b are examples of the type of terminal cable ends, generally 42 that would be held in place using the twist lock connector locking mechanism of FIGS. 1-8. The cable portion 44 is firmly affixed into the ferrules 46. Where the end of the ferrule 46 meets the cable there will be a small projecting edge 48 inboard from the end of the cable. This edge is the projecting edge 50 that will interface with planar surfaces formed in the locking rod when the cable end is inserted into the access bore of the header block 14 and the locking rods are rotated so the planar surfaces are generally perpendicular to the major axis of the cable. The planer surfaces, now rotated to be in a locking position, will block the cable from being pulled out of the access bore through contact between the planar surface and the edge of the ferrule of the cable.

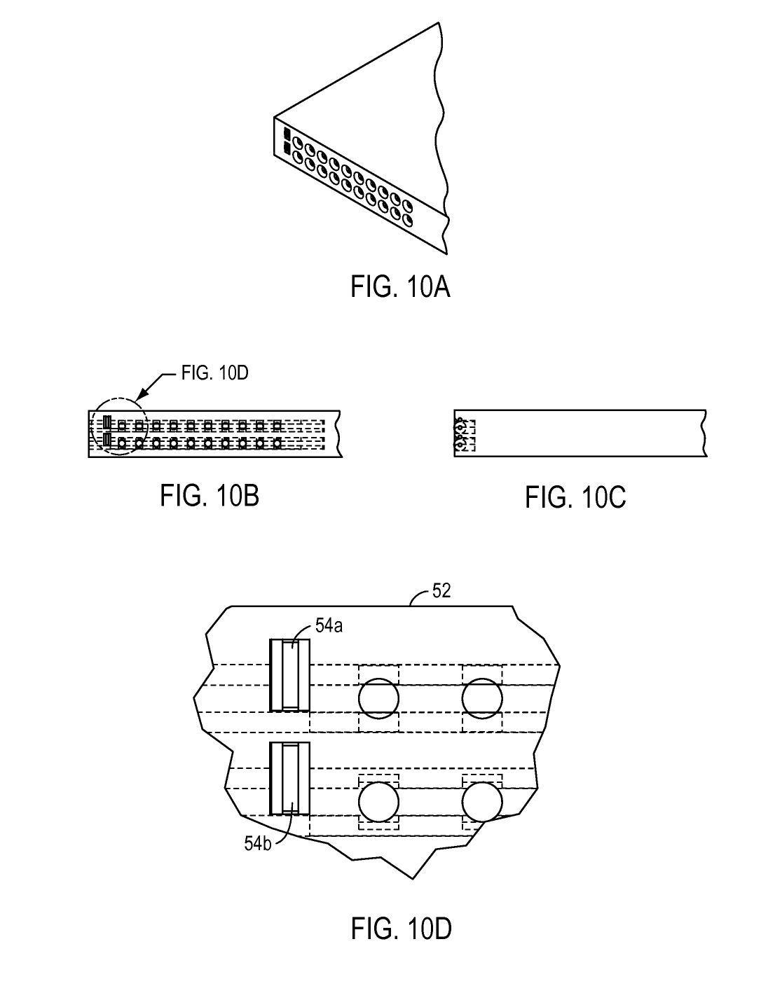

FIGS. 10a-10d are an embodiment of the invention where the locking rods are used with a piece of equipment such as an electrical enclosure. In FIG. 10d knurled knobs 54a and 54b, attached to each of an upper and a lower locking rod, protrude from a faceplate of the enclosure. The knobs 54a and 54b serve the purpose of rotating the respective locking rods into and out of a locking position to retain cables in the electrical enclosure. The locking connection is as explained above with the planer surfaces of the locking rods or rotatable shafts contacting the projecting edges on the ends of the cable ferrules to prevent the cables from being pulled out of the faceplate 52.

FIGS. 11a-11c are embodiments of locking rods used in the twist lock connector locking mechanism. FIG. 11a is a side elevation view of a locking rod such as 20 or 22. In this view there are ten planar surfaces such as planar surfaces 34. In the embodiments shown in the other figures there would be only six planar surfaces (and a flat for the set screw if desired) used on the locking rod as there are only six access bores in the embodiments shown in FIGS. 1, 2, 6, 7 and 12. The inventor contemplates that six access bores or cable receiving bores is a popular configuration. However, any number of access ports is also contemplated.

FIG. 11b is the rod shown in FIG. 11a rotated ninety degrees. In this view the planar flats would be in the locked position rather than in the open position shown in FIG. 11a. In this embodiment the locking rod doesn't show a set screw flat or a groove to allow the passage of the shank of a lead screw 18.

FIG. 11c is one embodiment of a locking rod or rotatable shaft, generally 58. This locking rod has planar flats such as 34. It also has an end 60 with a flat that accommodates a locking rod rotation apparatus (not shown in this figure). At the other end of the locking rod 58 is a circumferential groove 62 to accommodate a flat spring-type locking device such as 64 in FIG. 8. A setscrew flat 36 is formed on the locking bar inboard from the groove 62. This locking rod or rotatable shaft 58 embodiment doesn't include the groove in the locking rod as shown in FIG. 1.

Another planar surface, that being a flat 36 for the setscrew contact, is also shown.

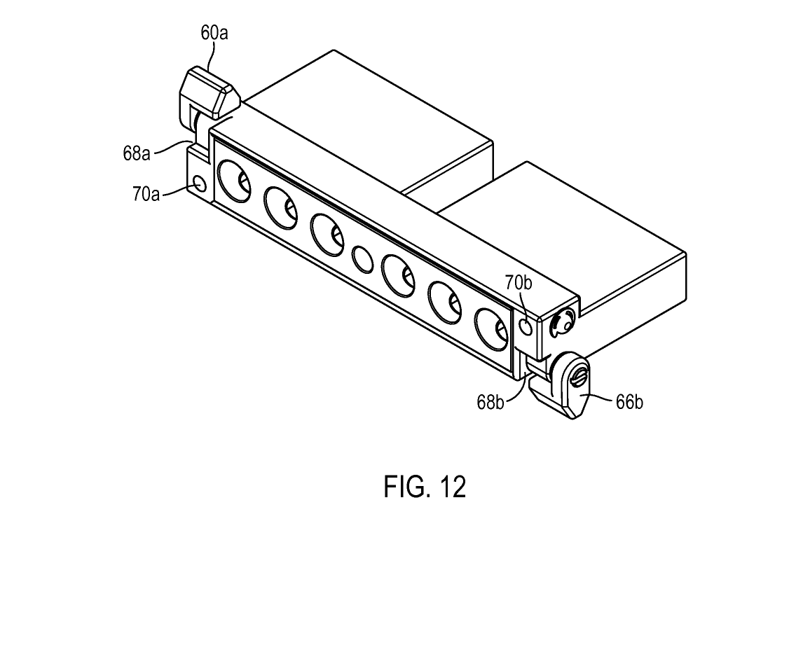

FIG. 12 is another embodiment of the invention. In this embodiment the locking bar rotation apparatus are not knurled knobs but are levers 66a and 66b that are attached to the ends of the rotating shafts or locking rods. The levers are sized to be rotatable into cutouts 68a and 68b in the header block. It is a matter of designer's choice as to the direction the levers are positioned to either lock or unlock the locking rods. In the embodiment shown in FIG. 12 the locking rods are in the open position ready to accept the ferrules of the cables. The levers would then be rotated to face relatively forward so the levers occupy the cutouts 68a and 68b. Once in the locked position setscrews in setscrew locations 70a and 70 b are tightened to restrain the locking rods from rotational movement.

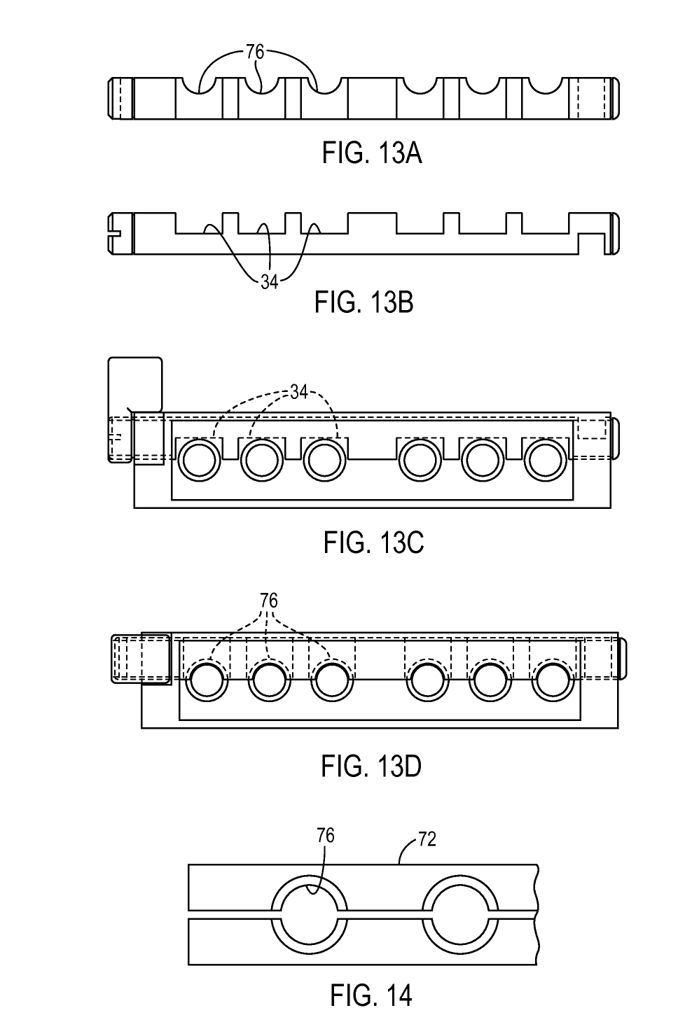

FIGS. 13a-d show another embodiment of a locking rod. FIGS. 13a and 13b depict a locking rod in a first position, FIG. 13a and in a second position, FIG. 13b, rotated or twisted ninety degrees from the first position. In the second position the flats 34 are clear. These flats 34 are modified as shown in FIG. 13a with a scallop or contour 76 formed in each flat. These contours provide a larger surface area in contact with the projecting edge 50 as shown in FIGS. 9a and 9b. The contour 76 will encircle, in this embodiment, just slightly less than half the diameter of the wire or cable 44 when in the inserted and locked position. This position is shown in FIG. 13d where the contours 76 are shown. The unlocked position is shown in FIG. 13c where the flats 34 are clearly seen.

FIG. 14 shows another embodiment of the locking rods or rotatable shafts. The modified locking rod 72 includes a contour 76 formed in the flat 74 (See FIGS. 13a and 13b). This contour 76, particularly when used in both an upper and a lower locking rod provides more surface area contact between the edge of the ferrule at the end of the cable and the locking rod contact surface. With both contour configured locking rods as shown in FIG. 14 the cable is very securely restrained between two locking rods.

The advantages of the device where the locking rods have the contours 76 formed in the flats 34 is that a larger contact area is made between the locking rods and the cable. Not only does this help securely hold the cable in the access bore but it also provides more surface area contact as the locking rod is rotated from the open position to the locked position and thus give more secure contact when the locking rod is urging or pushing the cable firmly into the access bore and in contact with the second connector positioned from the relative back side of the housing block into the access bore.

In summary, the invention presented is an apparatus configured to accept a connectorized end of a cable. The cable end has a projecting edge inboard from the terminal end of the connector at the end of the cable. The connector is engageable with the connectorized end of the cable. One embodiment of the apparatus comprises a housing with a first transverse bore extending into the housing. The housing also has more than a single access bore angularly displaced from the first transverse bore. These access bores extend into the housing and intersect the first transverse bore. There is a locking rod carried in the first transverse bore of the housing. This locking rod has a plurality of planar surfaces formed on the locking rod. The planar surfaces or flats are located to intersect the access bores when the locking rod is in the first transverse bore of the housing. Thus, when the locking rod is rotated the planar flats will urge a connectorized end of a cable into firm contact with a connector positioned in the access bore as the locking bar is rotated to a locking position. This happens when a connector is positioned in the access bore and a connectorized end of a cable is inserted into an access bore. The ends of the locking rod may also include a locking rod rotation enabling apparatus integral with the locking rod.

The bore that accepts the locking rod may be either a blind bore or a through bore. If it is a through bore it will extend from one exterior surface of the housing to another exterior surface of the housing.

In another embodiment of the device the apparatus will include a second transverse bore extending into the housing. This second transverse bore is adjacent the first transverse bore and is aligned with the first transverse bore as well as being spaced apart from the first transverse bore. It is also contemplated that more than a single access bore angularly displaced from the second transverse bore will be provided. These access bores will also extend into the housing and intersect the second transverse bore. The second transverse bore is provided to accommodate a second locking rod. This second locking rod will also have a plurality of planar surfaces or flats formed in the rod. The planar surfaces are formed, located, or positioned on the second locking rod to intersect the access bores when the second locking rod is in the second transverse bore of the housing.

Planer surfaces or flats on the locking rods are mentioned above. In another embodiment the flats can be formed with a contour formed in each flat of the locking rod. The contour is shaped, in one embodiment a portion of a circle, to closely surround at least a portion of a connectorized cable when a connectorized cable is inserted in an access bore and the locking rod is rotated to a locked position.

Another type of flat may be formed on the locking rod. This would be a retention element interfacing flat formed on the locking rod. It would be positioned to be contactable with a retention element that can contact the flat and prevent the locking rod from rotation when the retention element is engaged with the retention element interfacing flat.

In some instances or embodiments, usually depending on cable size, the vertical spacing between the two locking rods needs to be opened up to accept a housing retention lead screw. Thus the locking rods may have a groove formed in each locking rod, the groove approximately midway along each locking rod between two adjacent access bores.

Stated another way, and somewhat different from the summary above, is that the device here is a cable retention device for securely retaining a plurality of cables in a locking block fixture. This cable retention device includes, among other things, a bore in the locking block fixture and a locking rod carried in the bore. The locking rod has a plurality of planar surfaces or flats formed thereon. These flats present a margin at the circumferential surface of the locking rod. The margin will interface with a ferrule on each cable. The ferrule presents an edge contactable by the margin of the flats upon rotation of the locking rod of the cable retention device, and further the cable retention device urging cables into contact with a connector as the locking shaft of the cable retention device is rotated. In this embodiment upon initial insertion of the cable into the locking block fixture the cable is urged into contact with the connector and the cable is retained in the locking block fixture by contact between the ferrule edge of the cable and the margin presented by the flat intersection with the circumferential surface of the locking rod.

This embodiment can also include a locking rod rotation apparatus at the end of the locking rod so the locking rod can be rotated from an open position for accepting a cable to a locked position for retaining a cable in the cable retention device.

As discussed above, this embodiment can also have contours or scallops formed on the flats of the locking rod.

This embodiment, if desired or required, can also include a pair of bores and a pair of locking rods or rotating shafts carried in the bores. As is shown in the drawing figures, the bores are parallel to each other and spaced apart from each other such that a cable is retained by both locking rods simultaneously.

Locking rod rotation apparatus would be included in this embodiment if desired. They would be carried at the end of each locking rod such that each locking rod can be rotated from an open position for accepting a cable to a locked position for retaining a cable in the cable retention device.

The apparatus has been discussed above but it is also believed that the method of attaching cables using this system has merit. The method includes several acts for retaining a plurality of cables in a housing. These acts include inserting at least more than a single cable into at least more than a single access bore of the housing. The cables have ferrules providing an edge. There will be a locking rod carried in a bore of the housing. This locking rod has flats or planar surfaces formed thereon and these flats of the locking rod will contact the edge of each of the ferrules. The cables can be urged further into the access bores through contact between the flats of the locking rod and the edges of each of the ferrules as the locking rods are rotated. The locking rod is rotated until the cables are secure in the access bores. Normally the locking rod rotation from open to closed or locked is approximately ninety degrees.

Another embodiment will have a second bore and a second locking rod carried in the second bore.

In one embodiment of this method, the flats on the locking rods further have contours formed on the edge of the flats at the circumferential margin of the locking rod. Thus a cable inserted in an access bore between the bores and the locking rods carried in the bores will be contacted for nearly the entirety of the outside dimension of the cable. While the invention is described herein in terms of preferred embodiments and generally associated methods, the inventor contemplates that alterations and permutations of the preferred embodiments and methods will become apparent to those skilled in the art upon a reading of the specification and a study of the drawings.

Accordingly, neither the above description of preferred exemplary embodiments nor the abstract defines or constrains the invention. Rather, the issued claims variously define the invention. Each variation of the invention is limited only by the recited limitations of its respective claim, and equivalents thereof, without limitation by other terms not present in the claim.

1. Apparatus configured to accept a connectorized end of a cable, the cable end having a projecting edge inboard from the terminal end of a connector at the end of the cable, a connector engageable with the connectorized end of the cable, the apparatus comprising:
a housing;
a first transverse bore extending into the housing;
more than a single access bore angularly displaced from the first transverse bore, the access bores extending into the housing and intersecting the first transverse bore;
a locking rod carried in the first transverse bore of the housing, the locking rod having a plurality of planar surface formed in the locking rod, the planar surfaces positioned on the locking rod and located to intersect the access bores when the locking rod is in the first transverse bore of the housing, whereby the planar flats of the locking rod, will urge a connectorized end of a cable into firm contact with a connector positioned in an access bore as the locking rod is rotated to a locking position when a connector is positioned in an access bore and a connectorized end of a cable is inserted into an access bore.

2. The apparatus set forth in claim 1 further comprising a locking rod rotation enabling apparatus integral to the locking rod.

3. The apparatus set forth in claim 2 wherein the transverse bore is a through bore extending from one exterior surface of the housing to another exterior surface of the housing.

4. The apparatus set forth in claim 2 further comprising a second transverse bore extending into the housing, this second transverse bore adjacent the first transverse bore, aligned with the first transverse bore and spaced apart from the first transverse bore;
more than a single access bore angularly displaced from the second transverse bore, the access bores extending into the housing and intersecting the second transverse bore;
a second locking rod carried in the second transverse bore, the second locking rod having a plurality of planar surface formed in the locking rod, the planar surfaces positioned on the second locking rod and located to intersect the access bores when the second locking rod is in the second transverse bore of the housing.

5. The apparatus set forth in claim 1 further comprising a contour formed in each flat of the locking rod, the contour being shaped to closely surround at least a portion of a connectorized cable when a connectorized cable is inserted in an access bore and the locking rod is rotated to a locked position.

6. The apparatus of claim 5 wherein the contour comprises a portion of a circle.

7. The apparatus of claim 1 further comprising a retention element interfacing flat formed on the locking rod whereby a retention element can contact the flat and prevent the locking rod from rotation when the retention element is engaged with the flat.

8. The apparatus of claim 4 further comprising a groove formed in each locking rod, the groove approximately midway along each locking rod between two adjacent access bores.

9. A cable retention device for securely retaining a plurality of cables in a locking block fixture, the cable retention device comprising:
a bore in the locking block fixture;
a locking rod carried in the bore, the locking rod having a plurality of flats formed thereon, the flats presenting a margin at the circumferential surface of the locking rod, the margin formed to interface with a ferrule on each cable, the ferrule presenting an edge contactable by the margin of the flats upon rotation of the locking rod of the cable retention device, and further the cable retention device urging cables into contact with a connector as the locking rod of the cable retention device is rotated, whereby upon initial insertion of the cable into the locking block fixture the cable is urged into contact with the connector and the cable is retained in the locking block fixture by contact between the ferrule edge of the cable and the margin presented by the flat intersection with the circumferential surface of the locking rod.

10. The apparatus of claim 9 further comprising a locking rod rotation apparatus at the end of the locking rod whereby the locking rod can be rotated from an open position for accepting a cable to a locked position for retaining a cable in the cable retention device.

11. The apparatus of claim 9 comprising contours formed on the flats of the locking rod.

12. The apparatus of claim 9 further comprising a pair of bores and a pair of locking rods carried in the bores, the bores parallel to each other and spaced apart from each other, whereby a cable can be retained by both locking rods simultaneously.

13. The apparatus of claim 12 further comprising a locking rod rotation apparatus at the end of each locking rod whereby each locking rod can be rotated from an open position for accepting a cable to a locked position for retaining a cable in the cable retention device.

14. The apparatus of claim 12 comprising contours formed on the flats of the locking rods.

15. A method of retaining a plurality of cables in a housing, the acts comprising:
inserting at least more than a single cable, the cables having ferrules providing an edge, into at least more than a single access bore of the housing;
providing a locking rod carried in a bore of the housing, rotating a locking rod, the locking rod having flats formed thereon, whereby the flats of the locking rod will contact the edge of each of the ferrules;
urging the cables further into the access bores through contact between the flats of the locking rod and the edges of each of the ferrules;
continuing to rotate the locking rod until the cables are secure in the access bores.

16. The method of claim 15 further comprising the act of providing a locking rod rotation apparatus on the end of the locking rod whereby the locking rod can be rotated by adjusting the locking rod rotation apparatus from an open position approximately ninety degrees to a locked position.

17. The method of claim 15 further comprising the act of restraining the locking rod from further rotation once the cables are secure in the access bores.

18. The method of claim 15 further comprising the housing having a second bore and a second locking rod carried in the second bore.

19. The method of claim 15 wherein the flats on the locking rods further comprise contours formed on the edge of the flats at the circumferential margin of the locking rod.

20. The method of claim 18 wherein the flats on the locking rods further comprise contours formed on the edge of the flats at the circumferential margin of the locking rod whereby a cable inserted in an access bore between the bores and the locking rods carried in the bores will be contacted for nearly the entirety of the outside dimension of the cable.
